(19) United States
(12) Patent Application Publication
(10) Pub. No.: US 2021/0157622 A1
(43) Pub. Date: May 27, 2021

(54) ORCHESTRATION OF KUBERNETES MASTER NODE

(71) Applicant: International Business Machines Corporation, Armonk, NY (US)

(72) Inventors: Vijay Kumar Ananthapur Bache, Bangalore (IN); Arvind Rangarajan, Chennai (IN); Bhagyashree Jayaram, Bangalore (IN); Arun Nagarajan, Bangalore (IN)

(21) Appl. No.: 16/693,320

(22) Filed: Nov. 24, 2019

(51) Int. Cl. G06F 9/455; H04L 12/24; G06F 11/34

(52) U.S. Cl. CPC G06F 9/45558; H04L 41/0893; G06F 2009/45562; G06F 2009/45595; G06F 11/3495

(57) ABSTRACT

Container orchestration software that controls instantiation, deployment, revision and removal of containers located in more than one cloud (that is, each container is located in a single cloud, but the set of orchestrated containers includes containers in more than one cloud). In some embodiments, the container orchestration software takes the form of a master node. In some embodiments, the container orchestration software takes the form of a Kubernetes type master node.

### BACKGROUND

The present invention relates generally to the field of container orchestration, and more particularly to container orchestration using Kubernetes.

The Wikipedia entry for “container” (as of 11 Oct. 2019) states as follows: “OS-level virtualization refers to an operating system paradigm in which the kernel allows the existence of multiple isolated user-space instances. Such instances, called containers (Solaris, Docker), Zones (Solaris), virtual private servers (OpenVZ), partitions, virtual environments (VEs), virtual kernel (DragonFly BSD) or jails (FreeBSD jail or chroot jail), may look like real computers from the point of view of programs running in them. A computer program running on an ordinary operating system can see all resources (connected devices, files and folders, network shares, CPU power, quantifiable hardware capabilities) of that computer. However, programs running inside of a container can only see the container's contents and devices assigned to the container. On Unix-like operating systems, this feature can be seen as an advanced implementation of the standard chroot mechanism, which changes the apparent root folder for the current running process and its children. In addition to isolation mechanisms, the kernel often provides resource-management features to limit the impact of one container's activities on other containers. The term ‘container,’ while most popularly referring to OS-level virtualization systems, is sometimes ambiguously used to refer to fuller virtual machine environments operating in varying degrees of concert with the host OS, e.g. Microsoft's ‘Hyper-V Containers’.” (Footnotes omitted)

To address the ambiguity noted in the previous paragraph, as used herein the term “container” is hereby defined sufficiently broadly to include (but not be limited to) “fuller virtual machine environments operating in varying degrees of concert with the host OS” (as mentioned in the previous paragraph).

The Wikipedia entry for “orchestration (computing)” (as of 24 Sep. 2019) states as follows: “Orchestration is the automated configuration, coordination, and management of computer systems and software . . . . For Container Orchestration there are different solutions such as Kubernetes software or managed services such as AWS EKS, AWS ECS or Amazon Fargate. Usage[:] Orchestration is often discussed in the context of service-oriented architecture, virtualization, provisioning, converged infrastructure and dynamic datacenter topics. Orchestration in this sense is about aligning the business request with the applications, data, and infrastructure. The main difference between a workflow ‘automation’ and an ‘orchestration’ (in the context of cloud computing) is that workflows are processed and completed as processes within a single domain for automation purposes, whereas orchestration includes a workflow and provides a directed action towards larger goals and objectives. In this context, and with the overall aim to achieve specific goals and objectives (described through quality of service parameters), for example, meet application performance goals using minimized cost and maximize application performance within budget constraints.” (Footnotes omitted)

The Wikipedia entry for “Kubernetes” (as of 24 Sep. 2019) states as follows: “Kubernetes . . . is an open-source container-orchestration system for automating application deployment, scaling, and management . . . . It aims to provide a platform for automating deployment, scaling, and operations of application containers across clusters of hosts. It works with a range of container tools, including Docker. Many cloud services offer a Kubernetes-based platform or infrastructure as a service (PaaS or IaaS) on which Kubernetes can be deployed as a platform-providing service. Many vendors also provide their own branded Kubernetes distributions . . . . Kubernetes defines a set of building blocks (‘primitives’), which collectively provide mechanisms that deploy, maintain, and scale applications based on CPU, memory or custom metrics. Kubernetes is loosely coupled and extensible to meet different workloads. This extensibility is provided in large part by the Kubernetes API, which is used by internal components as well as extensions and containers that run on Kubernetes. The platform exerts its control over compute and storage resources by defining resources as Objects, which can then be managed as such . . . . Kubernetes node . . . . A Node, also known as a Worker or a Minion, is a machine where containers (workloads) are deployed. Every node in the cluster must run a container runtime such as Docker, as well as the below-mentioned components, for communication with the primary for network configuration of these containers. Kubelet: Kubelet is responsible for the running state of each node, ensuring that all containers on the node are healthy. It takes care of starting, stopping, and maintaining application containers organized into pods as directed by the control plane. Kubelet monitors the state of a pod, and if not in the desired state, the pod re-deploys to the same node. Node status is relayed every few seconds via heartbeat messages to the primary. Once the primary detects a node failure, the Replication Controller observes this state change and launches pods on other healthy nodes . . . . Container Resource Monitoring: Providing a reliable application runtime, and being able to scale it up or down in response to workloads, means being able to continuously and effectively monitor workload performance. Container Resource Monitoring provides this capability by recording metrics about containers in a central database, and provides a UI for browsing that data.”

In its current form, installations of Kubernetes typically include a “master node.” A node is a worker machine in Kubernetes (sometimes also known as a minion). A node may be implemented by a VM (virtual machine) and/or physical machine, depending on the cluster. Each node contains the services necessary to run pods and is managed by the master node for the cluster of worker machines. The services on a node typically include the container runtime, kubelet and kube-proxy. The nodes in a cluster are the machines (for example, VMs, physical servers) that run the applications and cloud workflows. The Kubernetes master node for a cluster controls each node in the cluster. A programmer, or a human information technology worker, rarely interacts with the worker machines directly.

### SUMMARY

According to an aspect of the present invention, there is a method, computer program product and/or system that performs the following operations (not necessarily in the following order): (i) receiving, by a master node of a container orchestration software, an orchestration input data set; (ii) determining, by the master node and based on the orchestration input data set, that: (a) a first container should be deployed within a first network, and (b) a second container should be deployed to a second network; (iii) deploying, by the master node, the first container in the first network; and (iv) deploying, by the master node, the second container in the second network. The determination that the first container should be deployed within the first network and the second container should be deployed to the second network is based upon at least the following key performance indicators: cost, performance, data protection policies and latency.

According to an aspect of the present invention, there is a method, computer program product and/or system that performs the following operations (not necessarily in the following order): (i) receiving, by a master node of a container orchestration software, an orchestration input data set; (ii) determining, by the master node and based on the orchestration input data set, that: (a) a first container should be removed from a first network, and (b) a second container should be removed from a second network; (iii) removing, by the master node, the first container in the first network; and (iv) removing, by the master node, the second container in the second network. The determination that the first container should be removed from the first network and the second container should be removed from the second network is based upon at least the following key performance indicators: cost, performance, data protection policies and latency.

According to an aspect of the present invention, there is a method, computer program product and/or system that performs the following operations (not necessarily in the following order): (i) receiving, by a master node of a container orchestration software, an orchestration input data set; (ii) determining, by the master node and based on the orchestration input data set, that a first container should be moved from a first network to a second network; (iii) creating, by the master node, a first container image of the first container as it is running in the first network; (iv) removing, by the master node, the first container in the first network; and (v) instantiating, by the master node and from the first container image, a new version of the first container in the second network. The determination that the first container should be moved is based upon at least the following key performance indicators: cost, performance, data protection policies and latency.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system; and

FIG. 4 is a block diagram view of a second embodiment of a system according to the present invention.

### DETAILED DESCRIPTION

Some embodiments of the present invention are directed to container orchestration software that controls instantiation, deployment, revision and removal of containers located in more than one cloud (that is, each container is located in a single cloud, but the set of orchestrated containers includes containers in more than one cloud). In some embodiments, the container orchestration software takes the form of a master node. In some embodiments, the container orchestration software takes the form of a Kubernetes type master node. This Detailed Description section is divided into the following subsections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

A “storage device” is hereby defined to be anything made or adapted to store computer code in a manner so that the computer code can be accessed by a computer processor. A storage device typically includes a storage medium, which is the material in, or on, which the data of the computer code is stored. A single “storage device” may have: (i) multiple discrete portions that are spaced apart, or distributed (for example, a set of six solid state storage devices respectively located in six laptop computers that collectively store a single computer program); and/or (ii) may use multiple storage media (for example, a set of computer code that is partially stored in as magnetic domains in a computer's non-volatile storage and partially stored in a set of semiconductor switches in the computer's volatile memory). The term “storage medium” should be construed to cover situations where multiple different types of storage media are used.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

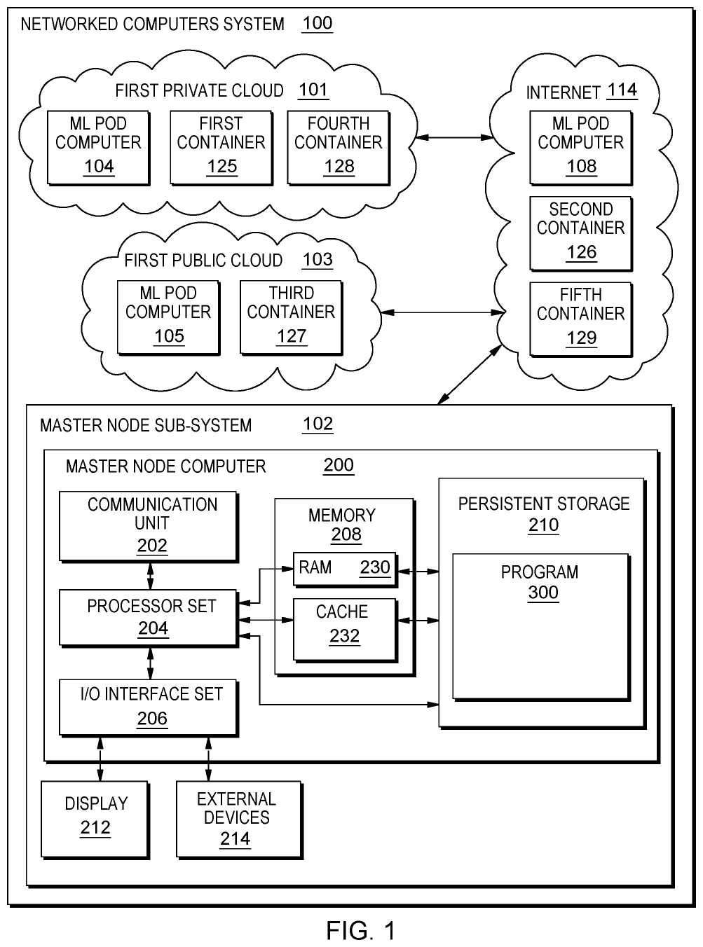

As shown in FIG. 1, networked computers system 100 is an embodiment of a hardware and software environment for use with various embodiments of the present invention. Networked computers system 100 includes: first private cloud 101; master node subsystem 102 (sometimes herein referred to, more simply, as subsystem 102); first public cloud 103; and internet 114. Master node subsystem 102 includes: master node computer 200; communication unit 202; processor set 204; input/output (I/O) interface set 206; memory 208; persistent storage 210; display 212; external device(s) 214; random access memory (RAM) 230; cache 232; and program 300. First private cloud 101 includes: ML (machine learning) pod computer 104; first container 125; and fourth container 128. First public cloud 103 includes: ML pod computer 105 and third container 127. Internet 114 includes: ML pod computer 108; second container 126; and fifth container 129.

Subsystem 102 may be a laptop computer, tablet computer, netbook computer, personal computer (PC), a desktop computer, a personal digital assistant (PDA), a smart phone, or any other type of computer (see definition of “computer” in Definitions section, below). Program 300 is a collection of machine readable instructions and/or data that is used to create, manage and control certain software functions that will be discussed in detail, below, in the Example Embodiment subsection of this Detailed Description section.

Subsystem 102 is capable of communicating with other computer subsystems via communication network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client subsystems.

Subsystem 102 is shown as a block diagram with many double arrows. These double arrows (no separate reference numerals) represent a communications fabric, which provides communications between various components of subsystem 102. This communications fabric can be implemented with any architecture designed for passing data and/or control information between processors (such as microprocessors, communications and network processors, etc.), system memory, peripheral devices, and any other hardware components within a computer system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for subsystem 102; and/or (ii) devices external to subsystem 102 may be able to provide memory for subsystem 102. Both memory 208 and persistent storage 210: (i) store data in a manner that is less transient than a signal in transit; and (ii) store data on a tangible medium (such as magnetic or optical domains). In this embodiment, memory 208 is volatile storage, while persistent storage 210 provides nonvolatile storage. The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202 provides for communications with other data processing systems or devices external to subsystem 102. In these examples, communications unit 202 includes one or more network interface cards. Communications unit 202 may provide communications through the use of either or both physical and wireless communications links. Any software modules discussed herein may be downloaded to a persistent storage device (such as persistent storage 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. I/O interface set 206 also connects in data communication with display 212. Display 212 is a display device that provides a mechanism to display data to a user and may be, for example, a computer monitor or a smart phone display screen.

In this embodiment, program 300 is stored in persistent storage 210 for access and/or execution by one or more computer processors of processor set 204, usually through one or more memories of memory 208. It will be understood by those of skill in the art that program 300 may be stored in a more highly distributed manner during its run time and/or when it is not running. Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

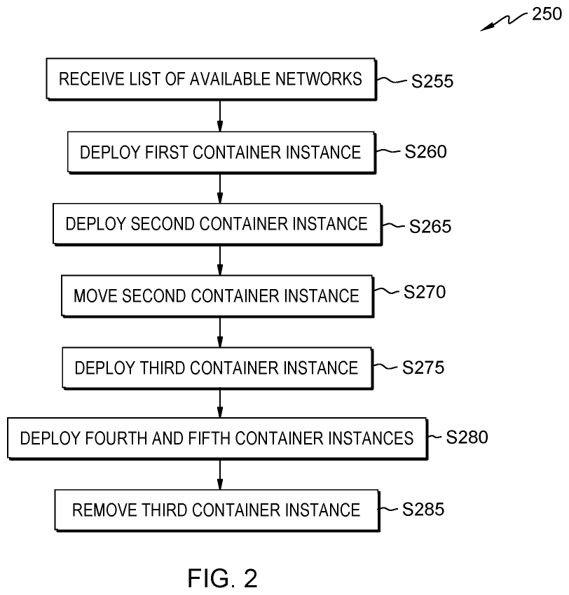

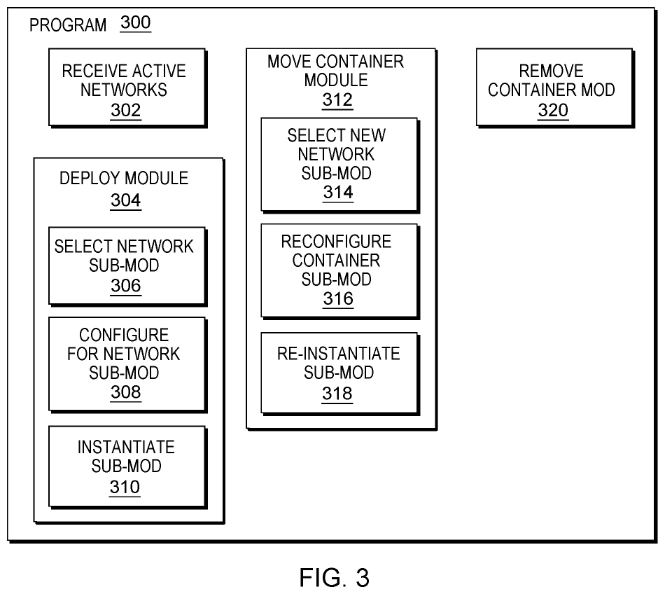

As shown in FIG. 1, networked computers system 100 is an environment in which an example method according to the present invention can be performed. As shown in FIG. 2, flowchart 250 shows an example method according to the present invention. As shown in FIG. 3, program 300 performs or controls the performance of at least some of the method operations of flowchart 250. This method and associated software will now be discussed, over the course of the following paragraphs, with extensive reference to the blocks of FIGS. 1, 2 and 3.

Processing begins at operation S255, where receive active networks module (“mod”) 302 of program 300 of master node subsystem 102 receives a list of active networks to which various containers may be deployed under the orchestration of master node subsystem 102. In this example there are three active networks as follows: first private cloud 101, first public cloud 103 and internet 114. At the time of operation S255 is performed, master node subsystem 102 has not yet deployed any container instantiations to any of the three active networks. It is noted that FIG. 1 shows the overall system at a later time, after several containers have been deployed by master node subsystem 102.

Processing proceeds to operation S260, where deploy mod 304 receives orchestration input data indicating that a new container should be deployed. The machine logic of select network sub-mod 306 of mod 304 determines, based on key performance indicators (as will be further discussed in the following subsection of this Detailed Description section), that it is best to deploy this new container to first private cloud 101, instead of first public cloud 103 or internet 114. Accordingly, configure for network sub-mod 308 configures an appropriate container image so that it can be deployed to first private cloud 101. Instantiate sub-mod 310 then instantiates first container 125 in first private cloud 101, where first container 125 then begins to do computing work.

Processing proceeds to operation S265, where deploy mod 304 receives orchestration input data indicating that another new container should be deployed. The machine logic of select network sub-mod 306 of mod 304 determines, based on key performance indicators (as will be further discussed in the following subsection of this Detailed Description section), that it is best to deploy this new container to first private cloud 101, instead of first public cloud 103 or internet 114. Accordingly, configure for network sub-mod 308 configures an appropriate container image so that it can be deployed to first private cloud 101. Instantiate sub-mod 310 then instantiates first container 125 in first private cloud 101, where second container 126 then begins to do computing work. It is noted that second container 126 is not shown in first private cloud 101 in FIG. 1 because FIG. 1 represents system 100 at a later point in time than the point in time of operation S265.

Processing proceeds to operation S270, where move container mod 312 receives orchestration input data indicating that second container 126 should be moved from first private cloud 101 to a different active network. The machine logic of select network sub-mod 314 of mod 312 determines, based on key performance indicators (as will be further discussed in the following subsection of this Detailed Description section), that it is best to move second container 126 to internet 114, instead of first public cloud 103. Accordingly, re-configure container sub-mod 316 re-configures second container 126 so that it can be re-deployed to internet 114. Re-instantiate sub-mod 318 then removes second container 126 from first private cloud 101, and re-instantiates first container 125 into internet 114 (see FIG. 1), where second container 126 continues to perform computing work.

Processing proceeds to operation S275, where deploy mod 304 receives orchestration input data indicating that a new container should be deployed. The machine logic of select network sub-mod 306 of mod 304 determines, based on key performance indicators (as will be further discussed in the following subsection of this Detailed Description section), that it is best to deploy this new container to first public cloud 101, instead of first private cloud 101 or internet 114. Accordingly, configure for network sub-mod 308 configures an appropriate container image so that it can be deployed to first private cloud 101. Instantiate sub-mod 310 then instantiates third container 127 in first public cloud 103 (see FIG. 1), where third container 127 then begins to do computing work.

Processing proceeds to operation S280, where more orchestration input data is received, and, in response, deploy mod 304: (i) deploys fourth container 128 to first private cloud 101; and (ii) deploys fifth container 129 to internet 114 (see FIG. 1).

Processing proceeds to operation S285, where more orchestration input data is received, and, in response, remove container mod 320 removes third container 127 from system 100 because it is no longer needed. It is noted that third container 127 is shown in FIG. 1 because FIG. 1 represents a point in time before operation S285 occurs.

### III. Further Comments and/or Embodiments

Some embodiments of the present invention recognize the following facts, potential problems and/or potential areas for improvement with respect to the current state of the art: (i) Kubernetes has emerged as the de facto standard for container orchestration on clouds; (ii) cloud solutions that use Kubernetes are mostly tied to a single provider though Kubernetes specifications allow for nodes to be spread across providers; (iii) while that unfolds the power of the Kubernetes architecture, it also inherits the drawbacks of the respective IaaS (infrastructure as a service) provider; (iv) the drawbacks could range from high costs, absence of data centers in a region, availability of bare metal options, etc.; (v) a problem with the architecture involving one or more cloud providers is, limiting the power of Kubernetes for changing client needs and leaving a lot of management at the client's hands to be performed manually; (vi) there is no way to dynamically utilize the advantages offered by a specific provider; (vii) this is often mitigated by additional cost-intensive services, multiple integration layers, lots of labour intensive tasks etc.; and/or (viii) so, there is a need for the Kubernetes based architecture to support a means to exploit the advantages of different cloud providers and at the same time preventing the need for clients to deal with complexities.

Some embodiments of the present invention recognize the following facts, potential problems and/or potential areas for improvement with respect to the current state of the art: (i) management of Kubernetes clusters across multiple cloud providers is supported today by means of solutions provided by different providers; (ii) these currently conventional solutions do not provide any intelligence and require the service teams and clients to manually estimate and provision the Kubernetes environments across cloud providers; (iii) manually monitoring is a difficult task considering there are multiple factors that affect efficient workload distribution like provider cost, data regulations, scaling, outages and maintenance to name a few; (iv) every change to the broader configuration requires an environment “outage”; (v) currently, Kubernetes uses a cluster, master node and worker Node components to manage the deployment units (known as pods) as per the deployment descriptor (YAML); and/or (vi) Kubernetes components are currently hosted on a single or multiple infrastructure(s) using software virtualization.

Some embodiments of the present invention may include one, or more, of the following operations, features, characteristics and/or advantages: (i) innovative orchestration of Kubernetes master node to optimize costs and workloads across cloud providers using machine learning; (ii) machine learning is introduced to overall Kubernetes workload management across cloud providers, right from provisioning, based on dynamic parameters that affect the solution's QoS (quality of service); (iii) with this invention, the worker nodes are made to run across multiple Cloud providers and the Kubernetes master node utilizes the monitoring parameters and decides how and where the pod ‘replicas’ will run in accordance with the Kubernetes specifications and additionally based on static and machine learning; (iv) some embodiments of the present invention deal with the manner in which the Kubernetes master node employs static and machine learning, based on inputs from YAML, monitoring and rules, to orchestrate the worker nodes and pods that are present across cloud providers; (v) the basic intelligence is prescribed in the deployment YAML file; (vi) the YAML file contains the preferred workload distribution; and/or (vii) the machine learning worker node provides necessary and sufficient information for the master node to manage the workloads based on pre-defined KPIs (key performance indicators) like cost, performance, data protection policies and latency.

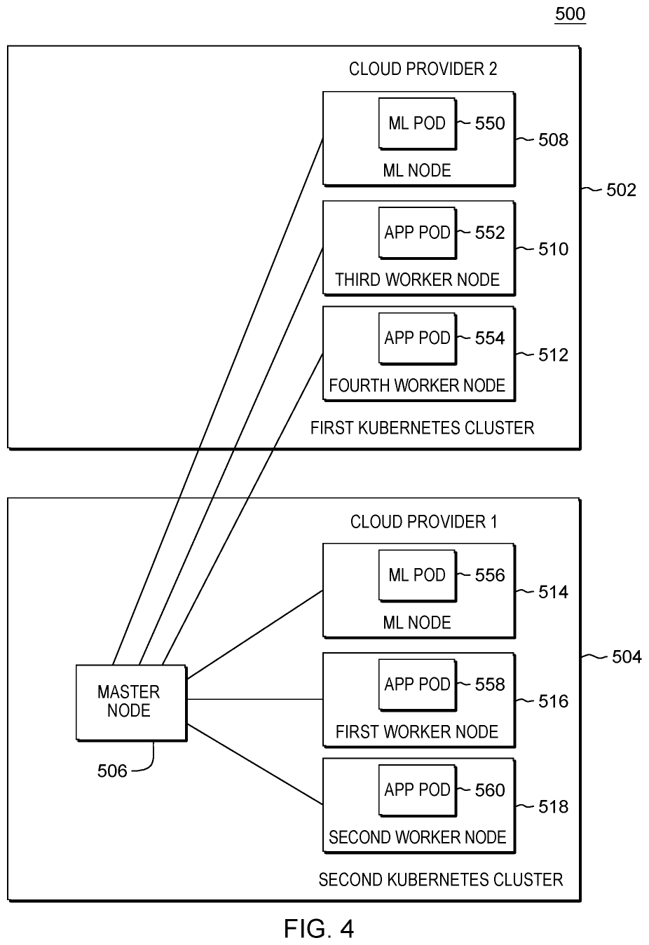

As shown in FIG. 4, the system 500 includes: first Kubernetes cluster 502; and second Kubernetes cluster 504. First Kubernetes cluster 502 includes: ML node 508 (including (ML pod 550); third worker node 510 (including app pod 552); and fourth worker node 512 (including app pod 554). Second Kubernetes cluster 504 includes: ML node 514 (including (ML pod 556); first worker node 516 (including app pod 558); and second worker node 518 (including app pod 560).

Kubernetes master node 506 is configured on one primary Kubernetes cluster and is connected to worker nodes 510, 512 configured on at least one cloud provider other than the cloud provider that provides for the cluster where the master node is located. Each cloud provider has one worker node dedicated for machine learning (ML) that understands the KPIs of that infrastructure. In the example of system 500: (i) the dedicated ML worker node for the cloud provider associated with first Kubernetes cluster 502 is ML node 508; and (ii) the dedicated ML worker node for the cloud provider associated with second Kubernetes cluster 504 is ML node 514. Alternatively, the ML node for second Kubernetes cluster 504 could be provided within master node 506 itself. These ML nodes 508, 514 provide dynamic inputs to master node 506, which decides where to deploy the pods.

For example, if the number of replicas is set to three (3), and non-peak loads are expected, the master node will use the inputs from the respective ML worker nodes and distribute two (2) pods on a low cost provider and one (1) pod on a high performance provider to balance the overall cost while not affecting the average response time. The ML worker nodes on each Cloud provider takes into account the peak load period, the respective provider's cost, the average processing times of the nodes, CPU and memory utilization, maintenance schedules and similar to provide inputs to the master node. The static learning is based on the additional information on the deployment YAML for the pods.

Code for an example is provided below:

workload:
name: “social media”
provider: “CP1Dallas”
name: “reporting”
provider: “CP2India”

Master node 506 combines these inputs to distribute the workloads and also provision the required capacity within each cloud provider. Overall, the QoS is maintained while efficiently managing the cost with no outage. The setup can be extended to any number for cloud providers and respectively associated sets of worker nodes.

Some embodiments of the present invention may include one, or more, of the following operations, features, characteristics and/or advantages: (i) utilizing deployment YAML file for containing preferred workload distribution and utilizing the machine learning (ML) for providing necessary and sufficient information for the master node to manage the workloads or where to deploy pods/deployment units based on pre-defined Key Performance Indicators (KPIs) such as cost, performance, data protection policies and latency; and/or (ii) considering, by the worker nodes on each cloud provider, the peak load period, the respective provider's cost, the average processing times of the nodes, CPU, memory utilization, and maintenance schedules, to provide inputs to the master node using ML for orchestration of the worker nodes.

Some embodiments of the present invention may include one, or more, of the following operations, features, characteristics and/or advantages: (i) provide efficient YAML based workload management on Kubernetes across multiple cloud providers; (ii) an advanced machine-learning enabled mechanism, that not only efficiently addresses workload deployments, but also covers the provisioning of the necessary operating capacity, or worker nodes, needed to run those workloads (deployment units); (iii) technology that is more real time and more dynamic; (iv) adapts to the workloads, and dynamically allocates based on various parameters that are explained in the original idea; (v) utilizing deployment YAML file for containing preferred workload distribution and utilizing the machine learning (ML) for providing necessary and sufficient information for the master node to manage the workloads or where to deploy pods/deployment units; (vi) leverages a proven platform (Kubernetes, YAML and Master node) to achieve efficient management and provisioning of workloads and capacity; (vii) extends the Kubernetes specification to distribute and replicate workloads efficiently; (viii) provides a dynamic, real-time adaptive solution to manage these workloads, which is the needed, at present, as the workloads, network and infrastructure is unpredictable, in a typical distributed cloud architecture; and/or (ix) provides resilience to the overall system.

Some embodiments of the present invention may include one, or more, of the following operations, features, characteristics and/or advantages: (i) utilizes the proven Kubernetes technology to manage workloads dynamically; (ii) leaves the orchestration to Kubernetes and provides the necessary data to Kubernetes through YAML and ML to manage the workloads; (iii) combines rules provided in YAML with the real time data like peak load performance; (iv) the input is from ML; (v) non-computing metric parameters like regulatory needs, cost and maintenance schedules are taken into account; (vi) decreases costs and/or places data in a desired geographical location; (vii) an ML based distribution caters to all the aspects that matter in a real enterprise scenario; (viii) addresses the actual client problems in a good way; (ix) takes into account a wide range of dynamic parameters like peak loads, regulatory needs, etc.; (x) automatically provisions worker nodes and/or automatically deploys workloads; (xi) provides a robust of method of operation where inputs from YAML and ML nodes are taken simultaneously; and/or (xii) automates worker node provisioning and/or ML based workload distribution.

Some embodiments of the present invention may include one, or more, of the following operations, features, characteristics and/or advantages: (i) works in the context of Kubernetes services which needs and employs a different method of operation (Kubernetes, YAML & ML); (ii) uses both static and dynamic rules along with machine learning to manage workloads; (iii) the machine learning is employed at runtime as opposed to applying rules at decision time; (iv) employs an ML based dynamic model to make efficient and dynamic decision at runtime; (v) ML based decision making helps workload distribution automatically at runtime including provision of new worker nodes/new capacity; (vi) YAML does specifies rules for workload distribution; (vii) addresses cost, performance, regulatory needs, peak load responses that are dynamic in nature; and/or (viii) defines the rules for workload distribution.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

1. A computer-implemented method (CIM) comprising:
receiving, by a master node of a container orchestration software, an orchestration input data set;
determining, by the master node and based on the orchestration input data set, that: (i) a first container should be deployed within a first network, and (ii) a second container should be deployed to a second network;
deploying, by the master node, the first container in the first network; and
deploying, by the master node, the second container in the second network;
wherein the determination that the first container should be deployed within the first network and the second container should be deployed to the second network is based upon at least the following key performance indicators: cost, performance, data protection policies and latency.

2. The CIM of claim 1 wherein:
the deployment of the first container includes instantiating the first container from a first container image; and
the deployment of the second container includes instantiating the second container from a second container image.

3. The CIM of claim 1 wherein the master node is located in the first network.

4. The CIM of claim 1 wherein:
the first network is a first public cloud; and
the second network is a second public cloud.

5. The CIM of claim 1 wherein:
the first network is a first private cloud; and
the second network is a second private cloud.

6. The CIM of claim 1 wherein:
the container orchestration software is Kubernetes; and
the master node is a Kubernetes master node.

7-20. (canceled)

21. A computer program product (CPP) comprising:
a set of storage device(s); and
computer code stored collectively in the set of storage device(s), with the computer code including data and instructions to cause a processor(s) set to perform at least the following operations:
receiving, by a master node of a container orchestration software, an orchestration input data set,
determining, by the master node and based on the orchestration input data set, that: (i) a first container should be deployed within a first network, and (ii) a second container should be deployed to a second network,
deploying, by the master node, the first container in the first network, and
deploying, by the master node, the second container in the second network;
wherein the determination that the first container should be deployed within the first network and the second container should be deployed to the second network is based upon at least the following key performance indicators: cost, performance, data protection policies and latency.

22. The CPP of claim 21 wherein:
the deployment of the first container includes instantiating the first container from a first container image; and
the deployment of the second container includes instantiating the second container from a second container image.

23. The CPP of claim 21 wherein the master node is located in the first network.

24. The CPP of claim 21 wherein:
the first network is a first public cloud; and
the second network is a second public cloud.

25. The CPP of claim 21 wherein:
the first network is a first private cloud; and
the second network is a second private cloud.

26. The CPP of claim 21 wherein:
the container orchestration software is Kubernetes; and
the master node is a Kubernetes master node.

27. A computer system (CS) comprising:
a processor(s) set;
a set of storage device(s); and
computer code stored collectively in the set of storage device(s), with the computer code including data and instructions to cause the processor(s) set to perform at least the following operations:
receiving, by a master node of a container orchestration software, an orchestration input data set,
determining, by the master node and based on the orchestration input data set, that: (i) a first container should be deployed within a first network, and (ii) a second container should be deployed to a second network,
deploying, by the master node, the first container in the first network, and
deploying, by the master node, the second container in the second network;
wherein the determination that the first container should be deployed within the first network and the second container should be deployed to the second network is based upon at least the following key performance indicators: cost, performance, data protection policies and latency.

28. The CS of claim 27 wherein:
the deployment of the first container includes instantiating the first container from a first container image; and
the deployment of the second container includes instantiating the second container from a second container image.

29. The CS of claim 27 wherein the master node is located in the first network.

30. The CS of claim 27 wherein:
the first network is a first public cloud; and
the second network is a second public cloud.

31. The CS of claim 27 wherein:
the first network is a first private cloud; and
the second network is a second private cloud.

32. The CS of claim 27 wherein:
the container orchestration software is Kubernetes; and
the master node is a Kubernetes master node.
